(19) United States
(12) Patent Application Publication
(10) Pub. No.: US 2025/0244270 A1
(43) Pub. Date: Jul. 31, 2025

(54) SYSTEMS AND METHODS FOR MEASURING THERMAL PROPERTIES OF SOLID SLAB MATERIALS

(71) Applicant: Thermtest Inc., Hanwell (CA)

(72) Inventors: David Landry, Cumberland Bay (CA); Dale Hume, Fredericton (CA)

(21) Appl. No.: 19/042,206

(22) Filed: Jan. 31, 2025

Related U.S. Application Data
(60) Provisional application No. 63/627,105, filed on Jan. 31, 2024.

(51) Int. Cl. G01N 25/20

(52) U.S. Cl. CPC G01N 25/20

(57) ABSTRACT

Systems and methods are disclosed for determining thermal properties of a slab of sample material. Measurement data is obtained from a transient plane source sensor in contact with a slab of sample material, where an insulative backing material is in contact with the slab of sample material opposite the transient plane source sensor. Power supplied to the transient plane source sensor over a measurement period is sufficient to provide a temperature response in an axial boundary of the slab of sample material. A non-linear fitting technique is applied to determine one or more modeled thermal properties of the sample material using a temperature equation that considers thermal properties of the insulative backing material. The slab of sample material may be isotropic or anisotropic.

### CROSS-REFERENCE TO RELATED APPLICATIONS

This application claims the benefit of U.S. Provisional Patent Application No. 63/627,105, filed on Jan. 31, 2024, the entire contents of which is incorporated herein by reference for all purposes.

### TECHNICAL FIELD

The present disclosure relates to measuring thermal properties of solid slab materials, and in particular to measuring thermal properties of solid slab materials using a transient plane source sensor.

### BACKGROUND

Transient plane source systems are used for transient measurements of thermal properties of thin materials, and can be used to determine thermal conductivity and/or diffusivity. A sensor is placed in contact with a single slab of sample material (asymmetric or single-sided set-up) or placed between two slabs of sample material (symmetric or double-sided set-up). An insulative backing material is placed in contact with the slab(s) of material opposite to the sensor, and pressure is applied to the insulative backing material to ensure good contact between the slab of material and the sensor. With the asymmetric or single-sided set-up, where only one side of the sensor is in contact with the slab of sample material, insulative backing material is applied directly to the other side of the sensor. The slab(s) of sample material may be isotropic (i.e. having thermal properties that do not change at any point for any direction) or homogeneous but anisotropic with a principal axis and associated plane (i.e. with one set of properties in the direction of the principal axis and another set of properties for any direction in the associated plane). Transient plane source measurements with these anisotropic samples should orient the surfaces of the sensor to be perpendicular to the principal axis.

To measure thermal properties of the sample materials, electricity is passed through the sensor to provide a constant power over the sensor area, which heats up the surrounding sample of material. The sensor acts as both a heating and a heat-sensing item. The electricity heats up the sensor and the surrounding sample material, and the resistance of the sensor is related to the temperature of the surrounding sample material. Accordingly, a time-dependent temperature increase of the sample material can be recorded, and thermophysical properties of the sample can be determined from the temperature data using temperature equations, which are generally a function of time and thermal properties of the sample material.

Boundary conditions for existing temperature equations used in a transient plane source slab method consider that the insulative backing material is perfect, i.e. that no heat leaves the specimen. Moreover, temperature equations are not defined for anisotropic slabs or for asymmetric set-ups where the effects of insulation are considered.

Accordingly, additional, alternative, and/or improved systems and methods for measuring thermal properties of solid slab materials remain highly desirable.

### SUMMARY

In accordance with one aspect of the present disclosure, a thermal property measurement method is disclosed, comprising: obtaining measurement data from a transient plane source sensor having a first surface in contact with a slab of sample material, wherein an insulative backing material is in contact with the slab of sample material at a surface of the slab of sample material opposite the transient plane source sensor, the measurement data obtained by the transient plane source sensor over a measurement period, and wherein the measurement data includes time data within the measurement period, measured temperature data of the slab of sample material, and a power supplied to the transient plane source sensor over the measurement period, the slab of sample material and the power supplied to the transient plane source sensor over the measurement period being configured to provide a temperature response in an axial boundary of the slab of sample material without providing a temperature response in a radial boundary of the slab of sample material; determining an initial guess of one or more thermal properties of the slab of sample material; applying a non-linear fitting technique to determine one or more modeled thermal properties of the slab of sample material using the initial guess of the one or more thermal properties and a temperature equation that is a function of the one or more thermal properties, time, and the power supplied to the transient plane source sensor, the temperature equation considering that the insulative backing material is a perfect insulator or that the insulative backing material has a known set of thermal properties, and wherein the one or more thermal properties of the slab of sample material is a fit parameter in the non-linear fitting technique; and outputting the one or more modeled thermal properties.

In some aspects, a second surface of the transient plane source sensor opposite the first surface is in contact with a second slab of sample material, and a second insulative backing material is in contact with the second slab of sample material at a surface of the second slab of sample material opposite the transient plane source sensor, the second slab of sample material and the second insulative backing material being identical to the slab of sample material and the insulative backing material, respectively.

In some aspects, the temperature equation considers that the insulative backing material has a known set of thermal properties.

In some aspects, a second insulative backing material is in contact with a second surface of the transient plane source sensor opposite the first surface.

In some aspects, the slab of sample material is anisotropic.

In some aspects, the slab of sample material is isotropic.

In some aspects, the temperature equation considers that the insulative backing material has a known set of thermal properties.

In some aspects, the temperature equation considers that the insulative backing material is a perfect insulator.

In some aspects, a thermal conductivity of the insulative backing material is less than one thirtieth of an expected thermal conductivity of the slab of sample material.

In some aspects, the slab of sample material has a height that is less than a radius of the transient plane source sensor and greater than 0.03 times the radius of the transient plane source sensor, and the slab of sample material has a radius that is larger than two times the radius of the transient plane source sensor.

In some aspects, the method further comprises determining a modeled volumetric heat capacity from the one or more modeled thermal properties.

In some aspects, the temperature equation is further a function of volumetric heat capacity, and the volumetric heat capacity is a further fit parameter in the non-linear fitting technique and is determined.

In some aspects, the method further comprises determining an initial guess of the volumetric heat capacity.

In some aspects, the temperature equation is further a function of volumetric heat capacity, and the method further comprises receiving user input of a value for the volumetric heat capacity.

In some aspects, the temperature equation is further a function of a temperature offset caused by the transient plane source sensor, and the temperature offset is a further fit parameter in the non-linear fitting technique and is determined.

In some aspects, the method further comprises determining an initial guess of the temperature offset.

In some aspects, the temperature equation is further a function of a time offset, and the time offset is a further fit parameter of the non-linear fitting technique and is determined.

In some aspects, the method further comprises determining an initial guess of the time offset.

In some aspects, the one or more modeled thermal properties of the slab of sample material each comprise one of: thermal diffusivity, thermal conductivity, and thermal effusivity.

In some aspects, any one or more of the one or more modeled thermal properties comprises an axial thermal conductivity, an axial thermal diffusivity, an axial thermal effusivity, a radial thermal conductivity, a radial thermal diffusivity, or a radial thermal effusivity.

In some aspects, the non-linear fitting technique is applied to a time window of the time data that is a subset of the measurement period.

In some aspects, the method further comprises calculating modeled temperatures outside the time window using the modeled directional thermal properties.

In accordance with another aspect of the present disclosure, a thermal property measurement system is disclosed, comprising: a processor; and a non-transitory computer-readable memory storing computer-executable instructions which, when executed by the processor, configure the system to perform the method of any one of the above aspects.

In some aspects, the computer-executable instructions, when executed by the processor, further configure the system to control the power supplied to the transient plane source sensor.

In some aspects, the system further comprises the power source and the transient plane source sensor.

In accordance with another aspect of the present disclosure, a non-transitory computer-readable memory storing computer-executable instructions is provided, which, when executed by a processor, configure the processor to perform the method of any one of the above aspects.

### BRIEF DESCRIPTION OF THE DRAWINGS

Further features and advantages of the present disclosure will become apparent from the following detailed description, taken in combination with the appended drawings, in which:

FIG. 1 shows a system for measuring one or more thermal properties of a solid slab of sample material;

FIG. 2 shows an exploded representation of an example of a transient plane source sensor used in the system of FIG. 1;

FIG. 3 shows a method of determining one or more thermal properties of a slab of sample material;

FIG. 4 shows an example of a method of determining an initial guess of a thermal property of the sample material;

FIG. 5 shows an example of a method of applying a non-linear fitting technique to determine one or more modeled thermal properties of the sample material;

FIG. 6 shows a graph of an example temperature transient obtained from measurement;

FIG. 7 shows a graph comparing the calculation of the present disclosure to another calculation method.

It will be noted that throughout the appended drawings, like features are identified by like reference numerals.

### DETAILED DESCRIPTION

In accordance with the present disclosure, systems and methods are disclosed for determining one or more thermal properties of a slab of sample material.

A thermal property measurement method in accordance with the present disclosure comprises obtaining measurement data from a transient plane source sensor having a first surface in contact with a slab of sample material, and where an insulative backing material is in contact with the slab of sample material at a surface of the slab of sample material opposite the transient plane source sensor. Measurement data is obtained by the transient plane source sensor over a measurement period. The measurement data includes time data within the measurement period, measured temperature data of the slab of sample material, and a power supplied to the transient plane source sensor over the measurement period. The power supplied to the transient plane source sensor over the measurement period is sufficient to provide a temperature response in an axial boundary of the slab of sample material without providing a temperature response in a radial boundary of the slab of sample material. Preferably, the slab of sample material has a height that is less than a radius of the transient plane source sensor and greater than 0.03 times the radius of the transient plane source sensor, and the slab of sample material has a radius that is larger than two times the radius of the transient plane source sensor. The slab of sample material may be isotropic or anisotropic. Further, preferably a thermal conductivity of the insulative backing material is less than one thirtieth of an expected thermal conductivity of the slab of sample material.

An initial guess of one or more thermal properties (e.g. thermal conductivity, diffusivity, and/or effusivity, etc.) of the slab of sample material is determined. A non-linear fitting technique is applied to determine one or more modeled thermal properties of the slab of sample material using the initial guess of the one or more thermal properties. In accordance with the present disclosure, a temperature equation used for determining a modeled temperature of the slab of sample material accounts for the insulative backing material and considers that the insulative backing material is a perfect insulator or that the insulative backing material has a known set of thermal properties. The temperature equation is a function of the one or more thermal properties of the sample material, time, and the power supplied to the transient plane source sensor, and as such the one or more thermal properties of the slab of sample material is/are a fit parameter in the non-linear fitting technique.

Advantageously, in accordance with the present disclosure, the temperature equation is corrected to consider that the insulative backing material is a perfect insulator or that the insulative backing material has a known set of thermal properties. Temperature equations are derived for both anisotropic and isotropic materials, and for symmetric and asymmetric test set-ups. Accordingly, accurate modeled thermal properties of the sample material can be determined quickly using the non-linear fitting technique disclosed herein and using a more accurate temperature equation specific to different test set-ups and sample types.

Moreover, in accordance with the present disclosure, other thermal properties of the sample material such as volumetric heat capacity are not necessarily a required input, and indeed volumetric heat capacity can also be determined using the techniques disclosed herein. In one embodiment, volumetric heat capacity of the sample material can be computed from the one or more modeled thermal properties as determined from the non-linear fitting technique. Specifically, an unscaled temperature equation (i.e. without being a function of volumetric heat capacity) may be used in the non-linear fitting process to determine the one or more modeled thermal properties, and can also be used to compute the volumetric heat capacity. Advantageously, since volumetric heat capacity is not a fit parameter (and thus there are fewer unknowns), the computation time to perform the non-linear fitting decreases. Alternatively, the volumetric heat capacity (and other parameters/offsets) could be fit parameters and determined during the non-linear fitting. As a further alternative, the volumetric heat capacity can be fixed to a value entered by the user, and the fitting algorithm constrained by this requirement.

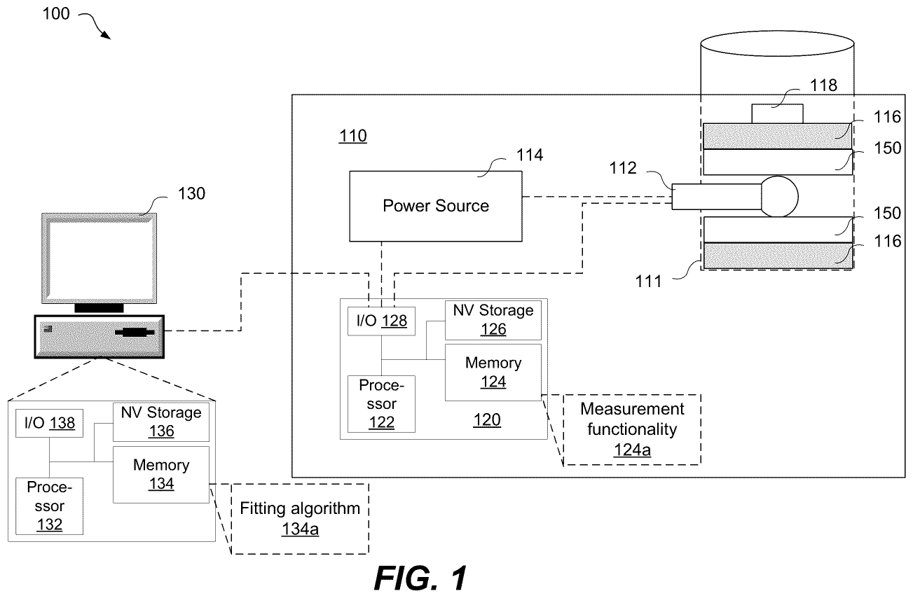

Embodiments are described below, by way of example only, with reference to FIGS. 1-7.

FIG. 1 shows a system 100 for measuring one or more thermal properties of a solid slab of sample material. The system 100 comprises a measurement device 110 that is configured to perform thermal measurements of a solid slab of sample material 150. The measurement device 110 comprises a transient plane source sensor 112 for measuring a temperature of the sample material in a measurement chamber 111. As described above, electricity is passed through the transient plane source sensor 112 to heat up the surrounding sample of material. The resistance of the sensor is related to the temperature of the surrounding sample material, and used to record a temperature of the sample material.

Depending on the test set-up, one or two solid slabs of sample material 150 may be placed in the measurement chamber 111. In accordance with the techniques disclosed in the present disclosure, the slab(s) of sample material 150 may be isotropic or anisotropic. The slab(s) of sample material 150 should have a height that is less than a radius of the transient plane source sensor and greater than 0.03 times the radius of the transient plane source sensor 112, and the slab(s) of sample material 150 should have a radius that is larger than two times the radius of the transient plane source sensor 112. This ensures that when power is supplied to the transient plane source sensor 112, a temperature response is triggered in the axial boundary of the slab(s) of sample material 150 without providing a temperature response in a radial boundary, which is required for the temperature equations described herein.

FIG. 1 shows a symmetric or double-sided set-up, with the transient plane source sensor 112 placed between two slabs of sample material 150. That is, a first surface of the transient plane source sensor is in contact with one slab of the sample material, and a second surface of the transient plane source sensor is in contact with a second slab of the sample material. An insulative backing material 116 is placed in contact with each slab of the sample material 150 to prevent axial heat leakage. That is, insulative backing material 116 is in contact with the slab of sample material 150 at a surface of the slab of sample material opposite the transient plane source sensor 112. The insulative backing material 116 thus sandwiches the slabs of sample material 150 together with the transient plane source sensor 112. A pressure source may be used to ensure sufficient contact between the sensor 112 and the sample material 150. As one example, a weight 118 (e.g. 10 lbs) may be placed on the top layer of insulation 116. With this symmetric test set-up, the two slabs of sample material 150 and the two insulative backing materials 116 should be identical.

In an alternative test set-up, referred to as an asymmetric or single-sided set-up, only one slab of sample material 150 is placed in the measurement chamber 111 (this test set-up is not shown in FIG. 1). In this case, a first surface of the transient plane source sensor 112 is in contact with one slab of the sample material 150 and insulative backing material 116 is in contact with the slab of the sample material 150 on the surface of the sample material 150 opposite to the surface of the transient plane source sensor 112, and a second insulative backing material 116 is in contact with a second surface of the transient plane source sensor 112 opposite the first surface.

The transient plane source sensor 112 is configured to receive electrical power from a power source 114, which causes the slab(s) of sample material 150 to heat up. The transient plane source sensor 112 acts as both a heating and a heat-sensing item. The electricity heats up the sensor 112 and the surrounding slab(s) of sample material 150, and the sensor 112 is used to measure a temperature of the sample material. In particular, the resistance of the sensor 112 is related to the temperature of the surrounding sample material 150, and a time-dependent temperature increase of the sample material 150 can thus be recorded.

A controller 120 is configured to control the power source 114 to supply the electric power to the transient plane source sensor 112, and is also configured to receive sensor data indicative of the temperature measurements from the sensor 112. The controller shown in FIG. 1 is shown as comprising a processing unit 122, which may for example be a central processing unit (CPU), a microprocessor, field programmable gate array (FPGA), or an application specific integrated circuit (ASIC). The controller 120 also comprises a non-transitory computer-readable memory 124, a non-volatile storage 126, and an input/output interface 128. The controller 120 is coupled to the power source 114 and the sensor 112 via I/O interface 118, and is configured to receive measurement data from the sensor 112 and to send commands to the power source 114. The controller 120 may also be coupled to one or more external processing devices and/or displays, such as external processing device 130, which may for example be a lab computer configured to send measurement commands to the controller 120 (e.g. what parameters to use for the thermal measurements), and the controller 120 is configured to send measurement data to the lab computer. The memory 124 of controller 120 stores non-transitory computer-readable instructions that are executable by the processing unit 122 to configure the controller 120 to execute certain methods and to provide certain functionality as described herein. In particular aspects, the system 100 is configured to measure thermal properties of sample materials that have isotropic or anisotropic thermal properties, wherein the measurement operation may depend on if the sample configuration is symmetric or asymmetric, and the memory 124 has computer-executable instructions stored thereon for implementing measurement functionality 124a, which when executed configure the controller 120 to perform certain functionality including control of the power source 114 and receiving the sensor measurements from sensor 112. It is also possible that the memory 124 has computer-executable instructions stored thereon for implementing a fitting algorithm (described below) to analyze the measurement data and determine one or more thermal properties of the sample material. The results of the data analysis at the controller 120 may be output to the external processing device 130 or a display on the measurement device 110, for example. However, in the example of FIG. 1 the data analysis is performed by the external processing device 130 that is communicatively coupled to the controller 120.

For performing a measurement in accordance with the present disclosure, the controller 120 is configured to control the power source 114 to supply the electric power at a pre-determined power and for a pre-determined time, the pre-determined power and the pre-determined time being sufficient for the sensor 112 to provide a temperature response on an axial boundary of the slab(s) of sample material 150 but not a radial boundary of the slab(s) of sample material 150. In accordance with the processing described herein, the slab(s) of sample material should have a height that is less than a radius of the transient plane source sensor and greater than 0.03 times the radius of the transient plane source sensor, and should have a radius that is larger than two times the radius of the transient plane source sensor. In some cases, the thickness requirement (i.e. the height of the sample material being smaller than a radius of the sensor) can be violated, but results will be worse (lower repeatability in thermal properties).

As an example, the sample material may comprise two anisotropic slabs that are polymers of thickness 2 mm and 5 cm wide and the manufacturing method is such that anisotropy is unavoidable. The height is verified with a micrometer and a 6.4 mm radius sensor is selected for the testing. The samples are placed in a sensor stand (with the sensor in between them) and polystyrene insulation is used to prevent axial heat leakage. A 10 lbs weight is put on top to ensure good contact between the sensor and samples. The insulation is used to meet the assumptions behind the mathematics. The insulators (in this example the polystyrene insulation) should have thermal conductivity less than one thirtieth of the expected conductivity of the slab(s) of sample material.

The power supplied to the sensor should be selected such that the temperature rise over the expected fit range is greater than some value that depends on the sensitivity of the system. As one example, it may be beneficial to control the power and operation time such that the increase in temperature is greater than 0.5° C. The selection of operation time should be in a way such that there is enough data points within the transient phase to ensure that all fit parameters or values required for curve fitting are clear and distinct from one another. In most embodiments, a general criterion exists for the measurements of thermal properties using the transient plane source methods where typically, the operation parameters are selected such that

$$\frac{κ {t}_{max}}{{a}^{2}}$$

is a value between 0.3 and 1 where k is the thermal diffusivity and tₘₐₓ is the maximum time. For measurements of an anisotropic slab in accordance with the present disclosure, replacing k in

$$\frac{κ {t}_{max}}{{a}^{2}}$$

with radial diffusivity, kᵣ, and axial diffusivity, k_{z}, then ensuring that the resulting value is between 0.3 and 1, generally provides a satisfactory criterion for most embodiments, however it will be appreciated that the disclosure is not limited to such.

As the sample is being heated by the sensor, for best results the heating should generally not reach the radial boundaries, which may for example be estimated using the following relationship: 3\sqrt{kᵣtₘₐₓ}<dₘᵢₙ, where dₘᵢₙ is the minimum distance from edge of sensor to edge of sample. In some embodiments, the value of 3 in the relationship can be replaced by other numbers should the system be more or less sensitive. A user may use estimated properties to get a sense of how long the test should be and an amount of power that should be supplied. In this example, 300 mW are applied over 20 s; and the response of the sensor over those 20 s is recorded and provided to the controller 120.

Measurement data comprising temperature measurements with respect to time are received from the transient plane source sensor 112, and may be analyzed by the controller 120 or be output for analysis, for example to the processing device 130. Note that in some embodiments, the processing device 130 may be part of the system 100 and sold with the measurement device 110, while in other embodiments the processing device 130 may be external to the measurement device 110, and may even be remote from the measurement device 110.

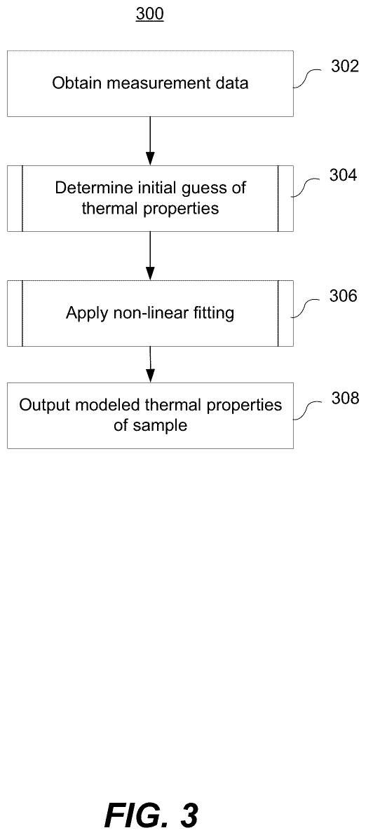

The processing device 130 comprises a processing unit 132, which may for example be a central processing unit (CPU), a microprocessor, field programmable gate array (FPGA), or an application specific integrated circuit (ASIC). The processing device 130 also comprises a non-transitory computer-readable memory 134, a non-volatile storage 136, and an input/output interface 138. The processing device 130 is coupled to the measurement device 110 via I/O interface 138, and is configured to receive measurement data including: the temperature and time data from the sensor 112 as well as the power data. The measurement data may be received from controller 120, or a combination of components of the measurement device 110. For example, the processing device 130 may receive the sensor data directly from the sensor 112. The processing device 130 also receives data defining the test set-up (e.g. symmetric or asymmetric) and properties of the insulative backing material 116 (e.g. a known set of thermal properties, or whether to consider the insulative backing material as a perfect insulator). The processing device may also receive an indication of whether the sample material to be tested is isotropic or anisotropic or unknown (or no indication may be provided). The memory 134 stores non-transitory computer-readable instructions that are executable by the processing unit 132 to configure the processing device 130 to execute certain methods and to provide certain functionality as described herein. In particular aspects, the processing device 130 is configured to execute a fitting algorithm 134a that configures the processing device 130 to determine one or more modeled thermal properties of the slab(s) of sample material 150 based on the measurement data. More specifically, the processing device 130 is configured to apply a non-linear fitting technique to the measurement data to determine one or more modeled thermal properties of the slab(s) of sample material 150. The non-linear fitting technique uses a temperature equation that is defined for the test set-up and accounts for the insulative backing material. Various other parameters, such as a height of the slab(s) of sample material, may be required in the temperature equation in the non-linear fitting technique. The height of the slab(s) of sample material may be determined using a micrometer that may be part of the measurement device 110. Methods for determining modeled thermal properties of the slab(s) of sample material 150 from the measurement data are described in more detail with reference to FIGS. 3 through 5.

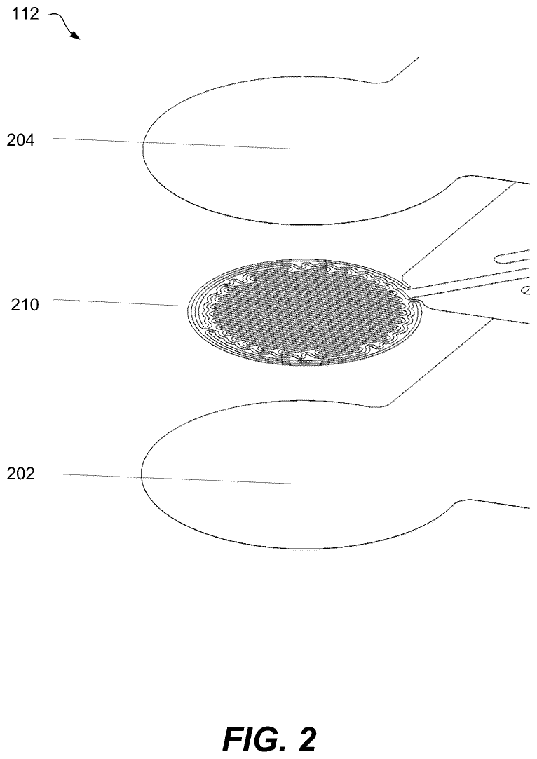

FIG. 2 shows an exploded representation of an example of transient plane source sensor 112 used in the system of FIG. 1. The sensor 112 comprises a base 202, a cover 204, and an electrically conductive heating element 210. FIG. 2 shows an exploded view of the sensor 112; when assembled, the electrically conductive heating element 210 is provided on the base (e.g, etched onto the base or otherwise placed onto the base), and the cover 204 is bonded to the base 202 to secure the electrically conductive heating element 210 in place. Bonding between the base 202 and cover 204 should be strong enough for them to be considered one element.

In use, and as described with reference to FIG. 1, the transient plane source sensor 112 is placed in contact with a sample material for measuring thermophysical properties of the sample material. The sensor 112 acts as both a heating and a heat-sensing item. The electrically conductive heating element 210 is configured to conduct electricity, which heats up the sensor and the surrounding sample material. The resistance of the electrically conductive heating element 210 is related to the temperature of the surrounding sample material. The electrically conductive heating element 210 may be made of an electrically conductive metal, such as nickel or platinum. The base 202 and the cover 204 may be made of an electrical insulating material such as Kapton®, mica, or polyetheretherketone (PEEK), for example. The base 202 and the cover 204 allow for the sample material to be heated by the electrically conductive heating element, while still providing a desired structural support for the electrically conductive heating element 210. Resistance recordings are taken during a measurement period for recording the time dependent temperature increase of the sample material. Electricity through the electrically conductive heating element 210 is provided via electrical leads coupled to the power source and is controlled by a controller as described with reference to FIG. 1. It will be appreciated that various types of transient plane source sensors could be used for the thermal property measurements in accordance with the present disclosure.

FIG. 3 shows a method 300 of determining one or more thermal properties of a slab of sample material. It will be appreciated that the sample material can be isotropic or anisotropic and the method adapted appropriately (for example, an anisotropic material has directional thermal properties, so determining a thermal property of an anisotropic material comprises determining the directional thermal properties). The method 300 may for example be performed by the controller 120 of the measurement device 110 or by an external processing device 130, as shown in FIG. 1. The method 300 may be performed by a processor when executing computer-executable instructions stored in a non-transitory computer-readable memory.

The method 300 comprises obtaining measurement data from a transient plane source sensor (302). The transient plane source sensor has a first surface in contact with a slab of sample material, and an insulative backing material is in contact with the slab of sample material at a surface of the slab of sample material opposite the transient plane source sensor. Depending on the test set-up (i.e. symmetric or asymmetric), a second surface of the transient plane source sensor may be in contact with a second slab of material which is in contact with a second insulative backing material (symmetric set-up), or the second surface of the transient plane source sensor may be in contact directly with a second insulative backing material (asymmetric set-up).

Preferably, the slab(s) of sample material has a height that is less than a radius of the transient plane source sensor and greater than 0.03 times the radius of the transient plane source sensor, and the slab of sample material has a radius that is larger than two times the radius of the transient plane source sensor. Further, preferably a thermal conductivity of the insulative backing material is less than one thirtieth of an expected thermal conductivity of the slab of sample material.

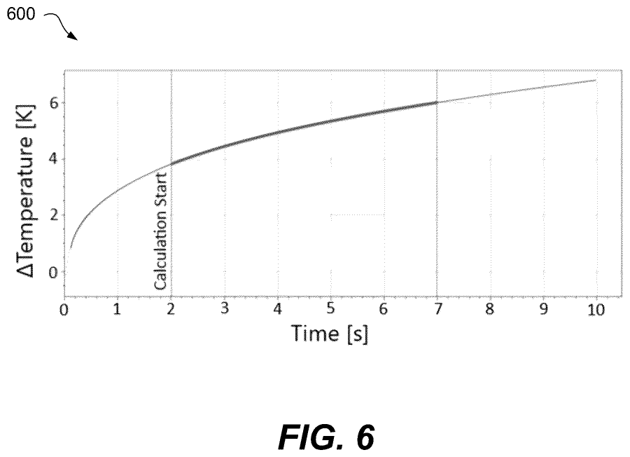

The measurement data from the transient plane source sensor is obtained over a measurement period and includes time data within the measurement period, measured temperature data of the sample material, and a power supplied to the transient plane source sensor over the measurement period. That is, the measurement data comprises a set of data obtained from the sensor comprising: a set of measured times t; a set of measured temperatures T, each corresponding to a specific measured time tᵢ; and a power supplied to the transient plane source sensor. FIG. 6 shows a graph 600 of an example temperature transient obtained from measurement, which is over a measurement period of 10 s performed on an anisotropic polymer and at a power of 500 mW.

An initial guess of one or more thermal properties of the sample material is determined (304). The one or more thermal properties may each be one of: thermal diffusivity, thermal conductivity, and thermal effusivity, depending on the temperature equation to be used. For an anisotropic sample, directional thermal properties are considered, and the initial guess includes an initial guess of radial and axial thermal properties.

Different procedures could be used to determine the initial guess of a thermal property of the slab of sample material. As described below, different temperature equations that account for the insulative backing material are used in a non-linear fitting technique according to the test set-up (symmetric or asymmetric) and boundary conditions set based on whether the insulative backing material is considered to be a perfect insulator or to have a known set of thermal properties. The temperature equations can be written for isotropic or anisotropic slabs (e.g. whether the thermal property is broken into directional components). In one example, the appropriate temperature equation can be used to determine an initial guess of the one or more thermal properties of the slab of sample material by using different values of the thermal properties to calculate modeled temperatures using the temperature equation, and comparing the modeled temperatures to the measured temperatures.

For example, an initial guess of axial and radial thermal properties of an anisotropic slab of sample material may be determined by calculating a plurality of modeled temperatures using a temperature equation for the test set-up that is a function of the axial and radial directional thermal properties and time (described in more detail below) over a range of axial and radial thermal property values, and comparing the plurality of modeled temperatures to the measured temperature data. The initial guess of the axial and radial directional thermal properties of the sample material may be taken as the axial and radial directional thermal properties providing modeled temperatures having a best linear fit to the measured temperature data. However, as noted above the guess procedure may be varied and alternative methods of determining an initial guess of the axial and radial directional thermal properties may be used.

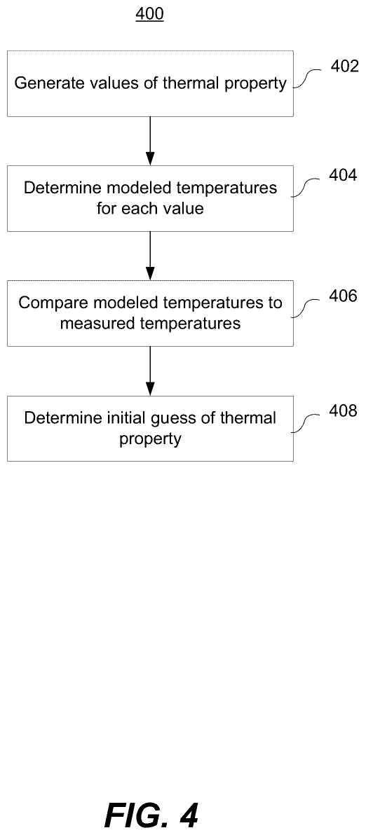

FIG. 4 shows an example of a method of determining an initial guess of a thermal property of a sample material. Where the temperature is a function of more than one thermal property, the method 400 can be modified to determine an initial guess of each thermal property of the temperature equation. As noted above, different methods could be used for determining an initial guess of a thermal property of the sample material, and different thermal properties may be used, and therefore the method 400 is non-limiting.

In the method 400, different values of the thermal property are generated (402). As an example, the sample material may be an anisotropic sample material and an initial guess of axial and radial thermal diffusivities of the sample material are to be determined. As a non-limiting example, different combinations of axial and radial diffusivities covering a predefined range of diffusivities that may be expected from solids, e.g. {1e⁻⁷, 2e⁻⁴} m²/s, may be generated in a predetermined amount of increments, e.g. 15 exponentially distributed increments.

Modeled temperatures are determined for each value of the thermal property (404). The modeled temperatures are determined by inputting the different generated values into a temperature equation for the test set-up and parameters. The modeled temperatures may be unscaled modeled temperatures as is the case when an unscaled temperature equation is used. The model temperatures may be calculated for a restricted set of time points.

The modeled temperatures are compared to the measured temperature data (406), for each value of the thermal property. Scaled modeled temperatures may be directly compared to the measured data. From the unscaled modeled temperatures, a linear fit may be applied using the measured temperature data from the measurement data as x-values and the unscaled modeled temperatures as y-values. By using the linear fit, it is possible to determine the coefficient of determination (R-squared value) for each value of the thermal property, which represents how good the modeled temperatures match the measured temperature data.

Based on the comparison of modeled temperatures to measured temperatures for each value of the thermal property, an initial guess of the value of the thermal property for use in non-linear fitting can be determined (408). That is, after calculating modeled temperatures for different values of the thermal property, the initial guess for the value of the thermal property may be selected as the value (or set of values, e.g. {kᵣᵢ, k_{zi}}) that resulted in the highest coefficient of determination (i.e. that provided modeled temperatures having a best fit to the measured temperature data).

Referring back to the method 300 of FIG. 3, a non-linear fitting technique is applied (306) to determine one or more modeled thermal properties of the sample material using the initial guess of the one or more thermal properties and a temperature equation that is a function of the one or more thermal properties, time, and the power supplied to the transient plane source sensor, and that considers that the insulative backing material is a perfect insulator or that the insulative backing material has a known set of thermal properties.

Non-linear fitting techniques work by iteratively changing fitting parameters in a calculation until the calculated results match a desired value. The non-linear fitting technique for determining the one or more modeled thermal properties of the sample material starts with the initial guess of the thermal properties of the sample material and considers the one or more thermal properties as a fit parameter that is iteratively updated to determine the modeled thermal property of the sample material.

As described above, temperature equations are derived in accordance with the test set-up (i.e. symmetric or asymmetric), parameters of the insulative backing material (i.e. whether it is a perfect insulator or has a known set of thermal properties), and whether the material is isotropic or anisotropic. In particular, the present disclosure provides five novel temperature equations corresponding to test configurations as follows: (1) symmetric test set-up with anisotropic slab and insulative backing material having known set of thermal properties; (2) asymmetric test set-up with anisotropic slab and insulative backing material having known set of thermal properties; (3) asymmetric test set-up with isotropic slab and insulative backing material having known set of thermal properties; (4) asymmetric test set-up with isotropic slab and insulative backing material being a perfect insulator; and (5) asymmetric test set-up with anisotropic slab and insulative backing material being a perfect insulator. The derivation of these temperature equations is described further herein.

It would be appreciated by a skilled person that for configurations (4) and (5), it may still be possible to consider the thermal properties of insulative backing material. As both configurations (4) and (5) are asymmetric test set-ups, the insulative backing material directly in contact with the transient plane source sensor on the surface opposite to the sample material may have a known set of thermal properties which may be considered. In contrast, the insulative backing material in contact with surface of the sample material opposite to the surface in contact with the sensor (for example, to prevent heat leakage in the far side of the sample material), may be considered to be a perfect insulator. Alternatively, both of the insulative backing material in contact with the transient plane source sensor and in contact with the sample material may be considered to be perfect insulators. It should be noted that the two insulative backing material may be the same material (i.e. material having the same set of thermal properties) or different materials (i.e. material having a different set of thermal properties).

In one of many possible forms, the general governing temperature equation can be written out as, noting that the sensor is located at z=0:

$${λ}_{r , s} {∇}_{r , s}^{2} V + {λ}_{z , s} {∇}_{z , s}^{2} V - ρ {c}_{p , s} \frac{\partial V}{\partial t} = - \frac{P}{A} H ( a - r ) δ ( z ) H ( t ) , \qquad \vert z \vert < h$$

with boundaries conditions of:

$${\frac{\partial V}{\partial z} \vert}_{\vert z \vert \to h} = 0 \& {V}_{r \to ∞} = 0$$

where P represents the constant power supplied over the sensor area A; the radius of the sensor is denoted as a; a height and a radius of the sample material is represented by h and aₛₐₘₚₗₑ, respectively; λ_{r,s} and λ_{z,s} represents the radial conductivity and the axial conductivity of the sample, respectively; the subscript s indicates that the value refers to the sample material being measured; ρc_{p,s} represents the volumetric heat capacity of the sample material; and H and δ are the Heavyside step function and the delta function, respectively,

The first boundary condition

$${\frac{\partial V}{\partial z} \vert}_{\vert z \vert \to h} = 0$$

has the restriction that the insulation used for the sample is perfect such that no heat escapes the system. It is also possible to instead consider the insulative backing material as a semi-infinite body with a set of known thermal properties, which is in contact with the sample material at +h/−h for the symmetric case and +h for the asymmetric case. By incorporating the known thermal properties of the insulative backing material for consideration, it is possible to characterize a new system that more accurately represents the thermal behavior of the sample material.

For a symmetric test set-up, the governing heat equation for the insulation material may be written as:

$${λ}_{r , b} {∇}_{r , b}^{2} V + {λ}_{z , b} {∇}_{z , b}^{2} V - ρ {c}_{p , b} \frac{\partial V}{\partial t} = 0 , \qquad \vert z \vert > h$$

where λ_{r,b} and λ_{z,b} represents the radial conductivity and the axial conductivity of the sample, respective; the subscript b indicates that the value refers to the insulative backing material; and ρc_{p,b} represents the volumetric heat capacity of insulation material.

In this combined system where the thermal properties of the insulative backing material are considered, the boundary conditions can be described as follows:

$$V ( z = ∞ ) = 0 , \qquad {{{λ}_{z , s} \frac{\partial V}{\partial z} \vert}_{h -} = {λ}_{z , b} \frac{\partial V}{\partial z} \vert}_{h +} , \qquad {λ}_{z , s} \frac{\partial V}{\partial z} = \frac{1}{R} ( {V}_{h -} - {V}_{h +} )$$

where R is the thermal contact resistance between the sample material and the insulation material.

A person skilled in the art will appreciate that simplifications/generalizations may be performed on the above equation systems for using in the measurement of sample materials. Further, mathematical transformations and/or adaptations may also be performed to produce equation(s) that are simple and easy to utilize for the calculations and determination of thermal properties.

According to one embodiment of the present disclosure, these equations can be simplified to eliminate the time component from the equation by using the Laplace transform. Doing so would introduce the Laplace parameter s. The variables q_{z,s}² and q_{z,b}² may be introduced to the system of equations for simplicity, where q=\sqrt{s/k}, where k is the thermal diffusivity and s is the Laplace parameter. Subscripts s and b indicate that the value corresponds to the sample material and the insulation material, respectively. It should be noted that s only refers to the sample material in reference to another value or property (i.e. denoted as a subscript). Other instances of s represent the Laplace parameter s. Subscripts z and r indicate that the value corresponds to the axial and radial direction (e.g. axial thermal diffusivity and radial thermal diffusivity), respectively. It should be noted that for an isotropic material, the values denoted using the subscripts z and r are equal to one another as the thermal properties are constant in the radial and axial directions (i.e. λ_{z}=λᵣ if the material is isotropic).

Next, the Hankel transform is taken. It would be apparent to a person skilled in the art that such an operation would introduce the Bessel function of the first kind, [symbol] ₁, to the equation relating to the sample material. The thus constructed differential equation system can now be considered as a multi-layered one dimensional system which may be solved using thermal quadrupoles and the assumption that

$${η}_{i}^{2} = \frac{{λ}_{r , i}}{{λ}_{z , i}} {σ}^{2} + {q}_{z , i}^{2}$$

where i may pe either s (representing sample material) or b (representing insulation material) and σ is the Hankel parameter. It would be appreciated that the expression of the initial flux, [symbol] (z=0), is used as the source term. The transformed flux is also defined as

$$\frac{P}{2 s A} \frac{{σ𝒥}_{1} ( a σ )}{σ} ,$$

which is required for solving the system. The system may then be solved by carrying out matrix multiplication and solving for the temperature at the source.

From this the inverse Hankel transform can be taken. However, this operation results in an integral without an analytical solution. As such, it may be beneficial to use the average over the radius of the sensor to simplify the equation, noting that the order of integration is interchangeable. The resulting temperature equation for symmetric test set-ups (shown below) may be used for the non-linear fitting technique (and the initial guess procedure in the example described above) to determine a thermal property of the sample material in the symmetric configuration. It should also be noted that the equation is written in the unscaled form:

$$\overline{V} ( z = 0 ) = \frac{P}{s A} {\int }_{0}^{∞} d σ \frac{{𝒥}_{1}^{2} ( a σ )}{σ} [ \frac{\frac{tanh ( h {η}_{s} )}{{λ}_{z , s} {η}_{s}} + R + \frac{1}{{λ}_{b} {γ}_{b}}}{1 + R {λ}_{z , s} {η}_{s} tanh ( h {η}_{s} ) + \frac{{λ}_{z , s} {η}_{s}}{{λ}_{b} {γ}_{b}} tanh ( h {η}_{s} )} ]$$

which is an equation expressed with regard to V̅, which is the Laplace'd temperature average. where λᵢγᵢ may also be expressed as either λ_{z,i}ηᵢ or λᵢ\sqrt{q_{r,i}²+σ²}, where i may be either s (representing sample material) or b (representing insulation material). Further, λᵢ may represent the bulk conductivity of the material i and q_{r,i} is the radial diffusivity associated with the material i (either sample material or insulation material). It would be appreciated that λᵢ=\sqrt{λ_{z,i}λ_{r,i}} and q_{r,i}=\sqrt{s/k_{r,i}}, where k_{r,i} is the thermal diffusivity in the radial direction and s is the Laplace parameter. As such, it is also possible to express ηₛ as

$$\sqrt{\frac{s}{{κ}_{z , s}} + {σ}^{2} \frac{{λ}_{r , s}}{{λ}_{z , s}}}$$

and γ_{b} as η_{b} or

$$\sqrt{\frac{s}{{κ}_{r , b}} + {σ}^{2}} .$$

Both the inverse Laplace transform and infinite integral may be required to be taken numerically. It would be appreciated that the above equation may be used to describe configuration (1) as previously defined.

A similar process may also be applied to a system with an asymmetric test set-up. As described previously, only one slab of sample material is in contact with the transient plane source sensor in the asymmetric test set-up. In an example embodiment of the present disclosure, the sample material is placed above the sensor (z>0) and the region below the sensor is filled with insulation material (i.e. the region where z<0). Accordingly, three heat equations (shown below) must be considered.

$${λ}_{r , b} {∇}_{r , b}^{2} V + {λ}_{z , b} {∇}_{z , b}^{2} V - ρ {c}_{p , b} \frac{\partial V}{\partial t} = - \frac{P}{2 A} H ( r - a ) δ ( z ) H ( t ) , \qquad z < 0$$

$${λ}_{r , s} {∇}_{r , s}^{2} V + {λ}_{z , s} {∇}_{z , s}^{2} V - ρ {c}_{p , s} \frac{\partial V}{\partial t} = - \frac{P}{2 A} H ( r - a ) δ ( z ) H ( t ) , \qquad 0 < z < h$$

$${λ}_{r , b} {∇}_{r , b}^{2} V + {λ}_{z , b} {∇}_{z , b}^{2} V - ρ {c}_{p , b} \frac{\partial V}{\partial t} = 0 , \qquad z > h$$

The boundary conditions for such a system can be described as follows:

$${V ( z = 0 )}_{+} = {V ( z = 0 )}_{-} , \qquad V ( z = ∞ ) = 0 ,$$

$${{{λ}_{z , s} \frac{\partial V}{\partial z} \vert}_{h -} = {λ}_{z , b} \frac{\partial V}{\partial z} \vert}_{h +} , \qquad {λ}_{z , s} \frac{\partial V}{\partial z} = \frac{1}{R} ( {V}_{h -} - {V}_{h +} )$$

which could be used to derive the following temperature equation that describes the temperature of the sample material at the origin for an asymmetric test set-up:

$$\overline{V} ( z = 0 ) = \frac{2 P}{s A} {\int }_{0}^{∞} d σ \frac{{𝒥}_{1}^{2} ( a σ )}{σ} {\{ {[ \frac{\frac{tanh ( h {η}_{s} )}{{λ}_{z , s} {η}_{s}} + R + \frac{1}{{λ}_{b} {γ}_{b}}}{1 + R {λ}_{z , s} {η}_{s} tanh ( h {η}_{s} ) + \frac{{λ}_{z ,} {η}_{s}}{{λ}_{b} {γ}_{b}} tanh ( h {η}_{s} )} ]}^{- 1} + {λ}_{b} {γ}_{b} \}}^{- 1}$$

The above equation may be derived numerically and may be used for the non-linear fitting technique (and the initial guess procedure in the example described above). It may be applied for the measurement of sample materials in the asymmetric configuration and may be used to describe configuration (2) as previously defined. It should also be noted that the equation is written in the unscaled form.

It would be appreciated that the above equation and derivation process can also be simplified further if the heat contribution at far side of the sample (i.e. at z=h) is negligible or if the sample is isotropic. For an isotropic sample, the equation can also be simplified by merging indices r, rz and z (i.e. the directional indices such as r, rz, and z may be disregarded or removed). Further, where the sample material is an isotropic slab, the above temperature equation for asymmetric test set-ups may be modified by setting the radial and axial thermal properties to be equal.

With regard to configuration (3), which describes an asymmetric test set-up with isotropic slab and insulative backing material having known set of thermal properties, the following equation may be derived for the system following the process as described above:

$$\overline{V} ( z = 0 ) = \frac{2 P}{s A} {\int }_{0}^{∞} d σ \frac{{𝒥}_{1}^{2} ( a σ )}{σ} {\{ {[ \frac{\frac{tanh ( h {η}_{s} )}{{λ}_{s} {η}_{s}} + R + \frac{1}{{λ}_{b} {γ}_{b}}}{1 + R {λ}_{s} {η}_{s} tanh ( h {η}_{s} ) + \frac{{λ}_{s} {η}_{s}}{{λ}_{b} {γ}_{b}} tanh ( h {η}_{s} )} ]}^{- 1} + {λ}_{b} {γ}_{b} \}}^{- 1}$$

which can also be simplified from the previous equation by noting that the directional thermal properties are equal (i.e. λₛ=λ_{r,s}=λ_{z,s}) and where

$${λ}_{b} = \sqrt{{λ}_{z , b} {λ}_{r , b}} , and {γ}_{b} = \sqrt{\frac{s}{{κ}_{r , b}} + {σ}^{2}} .$$

It should also be noted that as the sample material is isotropic, it is also possible to express ηₛ as

$$\sqrt{\frac{s}{{κ}_{s}} + {σ}^{2}} .$$

The boundary conditions used to derive the equation is as follows:

$${V ( z = 0 )}_{+} = {V ( z = 0 )}_{-} , V ( z = ∞ ) = 0 ,$$

$${λ}_{s} \frac{\partial V}{\partial z} {\vert}_{h -} = {λ}_{b} \frac{\partial V}{\partial z} {\vert}_{h +} , {λ}_{s} \frac{\partial V}{\partial z} = \frac{1}{R} ( {V}_{h -} - {V}_{h +} )$$

With regard to configuration (4), which describes an asymmetric test set-up with isotropic slab and insulative backing material being a perfect insulator, the following equations may be derived for the system following the process described previously:

$$\overline{V} ( z = 0 ) = \frac{2 P}{sA} {\int }_{0}^{∞} d σ {\frac{{𝒥}_{1}^{2} ( a σ )}{σ} [ {λ}_{s} {η}_{s} tanh ( h {η}_{s} ) + {λ}_{b} {γ}_{b} ]}^{- 1} ( a ) , and$$

$$\overline{V} ( z = 0 ) = \frac{2 P}{sA} {\int }_{0}^{∞} d σ {\frac{{𝒥}_{1}^{2} ( a σ )}{σ} [ {λ}_{s} {η}_{s} tanh ( h {η}_{s} ) ]}^{- 1} ( b )$$

$$where {λ}_{b} = \sqrt{{λ}_{z , b} {λ}_{r , b}} , {γ}_{b} = \sqrt{\frac{s}{{κ}_{r , b}} + {σ}^{2}} ,$$

and as the sample is isotropic,

$${η}_{s} = \sqrt{\frac{s}{{κ}_{s}} + {σ}^{2}} .$$

Equation (a) may represent an embodiment of configuration (4) wherein the insulative backing material directly in contact with the transient plane source sensor on the surface opposite to the sample material have a known set of thermal properties which are considered and that the insulative backing material in contact with surface of the sample material opposite to the surface in contact with the sensor (far side insulative backing material) is considered to be a perfect insulator. In comparison, equation (b) may represent an embodiment of configuration (4) wherein the insulative backing material in contact with the transient plane source sensor and the insulative backing material in contact with the sample material (i.e. all insulative backing material) are considered to be perfect insulators.

The boundary conditions used to derive equation (a) is as follows:

$${λ}_{b} {∇}_{b}^{2} V + {λ}_{b} {∇}_{b}^{2} V - ρ {c}_{p , b} \frac{\partial V}{\partial t} = - \frac{P}{2 A} H ( a - r ) δ ( z ) H ( t ) , z < 0$$

$${λ}_{s} {∇}_{s}^{2} V + {λ}_{s} {∇}_{s}^{2} V - ρ {c}_{p , s} \frac{\partial V}{\partial t} = - \frac{P}{2 A} H ( a - r ) δ ( z ) H ( t ) , 0 < z < h$$

$${V ( z = 0 )}_{+} = {V ( z = 0 )}_{-} , \frac{\partial V}{\partial z} {\vert}_{h -} = 0$$

Similarly, the conditions used to derive equation (b) is as follows:

$${λ}_{s} {∇}_{s}^{2} V + {λ}_{s} {∇}_{s}^{2} V - ρ {c}_{p , s} \frac{\partial V}{\partial t} = - \frac{P}{A} H ( a - r ) δ ( z ) H ( t ) , - h < z < 0$$

$${λ}_{s} {∇}_{s}^{2} V + {λ}_{s} {∇}_{s}^{2} V - ρ {c}_{p , s} \frac{\partial V}{\partial t} = - \frac{P}{A} H ( a - r ) δ ( z ) H ( t ) , 0 < z < h$$

$${V ( z = 0 )}_{+} = {V ( z = 0 )}_{-} , \frac{\partial V}{\partial z} {\vert}_{h -} = \frac{\partial V}{\partial z} {\vert}_{- ( h - )} = 0$$

It should be noted that for the above set of boundary conditions with regard to equation (b), the regions above and below the sensor (i.e. above and below 0) are described separately. However, the following set of boundary conditions may also be used to describe the system:

$${λ}_{s} {∇}_{s}^{2} V + {λ}_{s} {∇}_{s}^{2} V - ρ {c}_{p , s} \frac{\partial V}{\partial t} = - \frac{2 P}{A} H ( a - r ) δ ( z ) H ( t ) , - h < z < h$$

$$\frac{\partial V}{\partial z} {\vert}_{h -} = \frac{\partial V}{\partial z} {\vert}_{- ( h - )} = 0$$

With regard to configuration (5), which describes an asymmetric test set-up with anisotropic slab and insulative backing material being a perfect insulator the following equations may be derived for the system following the process described previously:

$$\overline{V} ( z = 0 ) = \frac{2 P}{sA} {\int }_{0}^{∞} d σ {\frac{{𝒥}_{1}^{2} ( a σ )}{σ} [ {λ}_{z , s} {η}_{s} tanh ( h {η}_{s} ) + {λ}_{b} {γ}_{b} ]}^{- 1} ( c ) , and$$

$$\overline{V} ( z = 0 ) = \frac{2 P}{sA} {\int }_{0}^{∞} d σ {\frac{{𝒥}_{1}^{2} ( a σ )}{σ} [ {λ}_{z , s} {η}_{s} tanh ( h {η}_{s} ) ]}^{- 1} ( d )$$

where

$${λ}_{b} = \sqrt{{λ}_{z , b} {λ}_{r , b}} , {γ}_{b} = \sqrt{\frac{s}{{κ}_{r , b}} + {σ}^{2}} ,$$

and as the sample is anisotopic,

$${η}_{s} = \sqrt{\frac{s}{{κ}_{z , s}} + {σ}^{2} \frac{{λ}_{r , s}}{{λ}_{z , s}}} .$$

Equation (c) may represent an embodiment of configuration (4) wherein the insulative backing material directly in contact with the transient plane source sensor on the surface opposite to the sample material have a known set of thermal properties which are considered and that the insulative backing material in contact with surface of the sample material opposite to the surface in contact with the sensor (far side insulative backing material) is considered to be a perfect insulator. In comparison, equation (d) may represent an embodiment of configuration (5) wherein the insulative backing material in contact with the transient plane source sensor and the insulative backing material in contact with the sample material (i.e. all insulative backing material) are considered to be perfect insulators.

The boundary conditions used to derive equation (c) is as follows:

$${λ}_{r , b} {∇}_{r , b}^{2} V + {λ}_{z , b} {∇}_{z , b}^{2} V - ρ {c}_{p , b} \frac{\partial V}{\partial t} = - \frac{P}{2 A} H ( a - r ) δ ( z ) H ( t ) , z < 0$$

$${λ}_{r , s} {∇}_{r , s}^{2} V + {λ}_{z , s} {∇}_{z , s}^{2} V - ρ {c}_{p , s} \frac{\partial V}{\partial t} = - \frac{P}{2 A} H ( a - r ) δ ( z ) H ( t ) , 0 < z < h$$

$${V ( z = 0 )}_{+} = {V ( z = 0 )}_{-} , \frac{\partial V}{\partial z} {\vert}_{h -} = 0$$

Similarly, the conditions used to derive equation (d) is as follows:

$${λ}_{r , s} {∇}_{r , s}^{2} V + {λ}_{z , s} {∇}_{z , s}^{2} V - ρ {c}_{p , s} \frac{\partial V}{\partial t} = - \frac{P}{A} H ( a - r ) δ ( z ) H ( t ) , - h < z < 0$$

$${λ}_{r , s} {∇}_{r , s}^{2} V + {λ}_{z , s} {∇}_{z , s}^{2} V - ρ {c}_{p , s} \frac{\partial V}{\partial t} = - \frac{P}{A} H ( a - r ) δ ( z ) H ( t ) , 0 < z < h$$

$${V ( z = 0 )}_{+} = {V ( z = 0 )}_{-} , \frac{\partial V}{\partial z} {\vert}_{h -} = \frac{\partial V}{\partial z} {\vert}_{- ( h - )} = 0$$

It should be noted that for the above set of boundary conditions with regard to equation (d), the regions above and below the sensor (i.e. above and below 0) are described separately. However, the follow set of boundary conditions may also be used to describe the system:

$${λ}_{r , s} {∇}_{r , s}^{2} V + {λ}_{z , s} {∇}_{z , s}^{2} V - ρ {c}_{p , s} \frac{\partial V}{\partial t} = - \frac{2 P}{A} H ( a - r ) δ ( z ) H ( t ) , - h < z < h$$

$$\frac{\partial V}{\partial z} {\vert}_{h -} = \frac{\partial V}{\partial z} {\vert}_{- ( h - )} = 0$$

It should be noted that while each of the temperature equations may be applied for a specific configuration, it is also possible for a different equation to be used as an approximation to reduce calculation load. In particular, a combination of equations may be used for accuracy and efficiency. For example, it may be possible to use equation for configuration (3), which is a simpler equation to perform curve fitting and calculations with, for the initial guess procedure where a reasonable guess is used for the value of R (i.e. 1e⁻⁵ m²K/W) while the more complicated equation for configuration (5) is used for the final non-linear fitting process.

It will also be appreciated that any of the temperature equations for asymmetric test set-ups may be rewritten to replace the axial and radial thermal diffusivities with axial and radial thermal conductivities and/or axial and radial thermal effusivities, and vice versa. For example, a relationship between volumetric heat capacity, ρCₚ, and directional properties of thermal diffusivities kᵣ, k_{z} and thermal conductivities λᵣ, λ_{z} is shown in the following equation.

$$ρ {C}_{p} = \frac{{λ}_{r}}{{κ}_{r}} = \frac{{λ}_{z}}{{κ}_{z}}$$

The above temperature equations for symmetric and asymmetric test set-ups may be considered to be unscaled temperature equations because they are independent of the volumetric heat capacity of the sample and the units of the temperature equations are not units of temperature. Other fitting parameters, such as a temperature offset (caused by the sensor interface) and/or a time offset (e.g. caused by sensor effects) could be considered. For each fitting parameter, an initial guess of the fitting parameter is passed to the non-linear fitting. As described above, the means of determining the initial guess may vary. An initial guess of volumetric heat capacity and/or temperature offset may be obtained from the slope of the best linear fit described with reference to the method 400. Otherwise, an initial guess of the volumetric heat capacity and/or temperature offset could be a generic value and/or input by the user. An initial guess of the time offset could simply be a best guess of the operator of the measurement system 110.

Accordingly, the non-linear fitting may be performed using just the thermal properties as fit parameters, or a combination of fitting parameters including the thermal properties and one or more of volumetric heat capacity, temperature offset, and time offset. However, it will also be appreciated that as the number of fit parameters increase, the computation time of the non-linear fitting increases, and therefore in certain situations it may be advantageous to determined thermal properties of the sample material using a smaller number of fitting parameters.

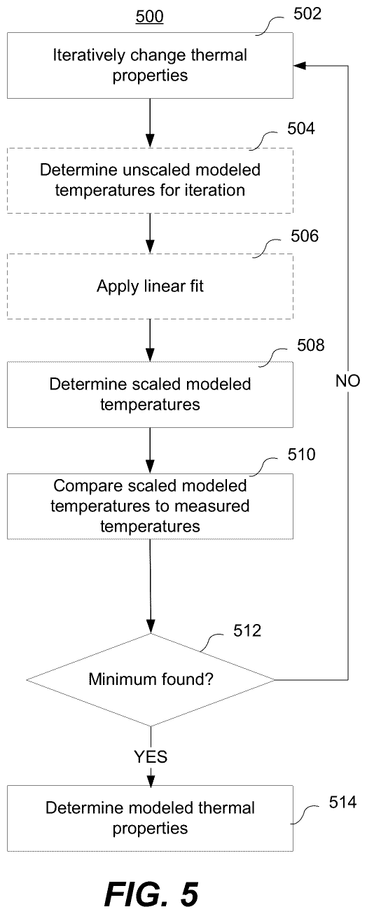

FIG. 5 shows an example of a method of applying a non-linear fitting technique to determine one or more modeled thermal properties of the sample material, where the volumetric heat capacity, temperature offset, and time offset are not used as a fitting parameter. In one example, a Levenberg-Marquardt fitting algorithm may be used where the fit parameter is one or more thermal properties (e.g. thermal conductivity, diffusivity, and/or effusivity) of the sample material. However, it will also be appreciated that other non-linear fitting algorithms and techniques can be used. The one or more thermal properties that are the fit parameters is dependent on the temperature equation used based on the test set-up.

The method 500 comprises iteratively changing values of the one or more thermal properties (502), starting with the initial guess of the one or more thermal properties. The manner in which the values of the thermal properties is iteratively changed can vary depending on the non-linear fitting technique.

Scaled modeled temperatures are calculated for each value of the one or more thermal properties (508). In some embodiments, unscaled modeled temperatures (i.e. that are not a function of volumetric heat capacity, temperature offset, etc.) may first be calculated (504) using an unscaled temperature equation for the symmetric or asymmetric test set-up as described above. In other embodiments, the scaled modeled temperatures may be calculated using a temperature equation that is a function of the volumetric heat capacity, temperature offset, etc. If these properties are present in the temperature equation but are not to be considered as fit parameters, values for these properties may be received as user input.

To calculate unscaled modeled temperatures, at each iteration the value(s) of the one or more thermal properties are input to the unscaled temperature equation for the symmetric or asymmetric test set-up as described above, and unscaled modeled temperatures are determined over a set of times (504). A linear fit is applied (506) to the unscaled modeled temperatures and the measured temperature data to find the slope and intercept. For example, a linear fit may be applied using the measured temperature data from the measurement data as x-values and the unscaled modeled temperatures as y-values. In this case, the slope of the linear fit is the inverse of volumetric heat capacity, and the intercept represents a temperature offset due to sensor contact. Using a linear fit in this manner to determine the volumetric heat capacity and temperature offset removes dependence on these parameters as fit parameters, which would greatly increase computation time. By applying the slope and intercept from the linear fit, scaled modeled temperatures can be determined (508).

The scaled modeled temperatures for a current iteration are compared to the measured temperature data (510). A determination is made as to whether a minimum difference between the scaled modeled temperatures and the measured temperature data has been found (512). If the minimum has not been found (NO at 512), the method 500 returns to 502 and iteratively changes values of the one or more thermal properties. If the minimum has been found (YES at 512), the one or more modeled thermal properties of the sample material is determined (514) as the value of the thermal properties for the iteration producing the minimum.

Referring back to FIG. 3, the one or more modeled thermal properties of the sample is output (308).

One or more other thermal properties of the sample may be determined from the one or more modeled thermal properties. For example, the method may further comprise determining a volumetric heat capacity of the sample material, if the volumetric heat capacity was not already a fit parameter. For example, the best fit volumetric heat capacity is the inverse of the slope of the linear fit determined at 506, for the iteration providing the minimum. If the modeled thermal property is thermal diffusivity, the thermal conductivity of the sample material can be calculated from the relation of thermal diffusivity, thermal conductivity, and volumetric heat capacity, and vice versa if the modeled thermal property is thermal conductivity.

The non-linear fitting technique may be applied to a time window that is a subset of the measurement period. For example, a fitting window {tᵢ, t_{f}} may be selected where tᵢ and t_{f} represent the start and end of the window and encompasses the set of time data between tᵢ and t_{f} and their corresponding temperatures. The data from this fitting window may used for the fitting algorithm and in some embodiments may for example be from 0.15 s since the start of the measurement period until the end of the measurement period. The method may further comprise calculating modeled temperatures outside the time window using the modeled thermal property.

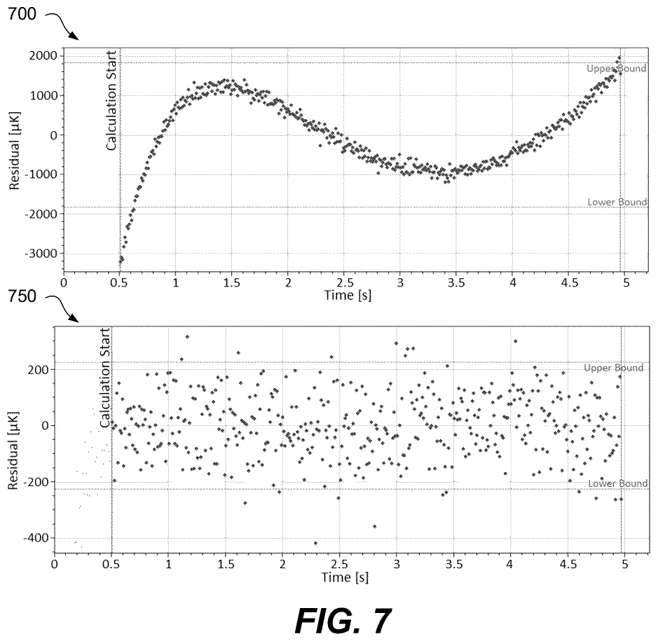

FIG. 7 shows graphs comparing the calculation method of the present disclosure where the properties of the insulative backing material are included the calculation to a calculation method where the properties of the insulative backing material are not considered (i.e. considered to be perfect insulators). In graph 700 of FIG. 7, the residual values for one embodiment using the calculation method of the present disclosure is shown. The thermal properties of a stainless steel slab placed in configuration (3) is determined with silicone rubber being used as the insulative backing material by heating the sample for 5 s at a power of 500 mW, as shown in FIG. 6. The chosen timing window for the analysis is between 0.5 s to 5 s. In the selected window, the corresponding residual values for each time point can be seen. Residuals are calculated as the difference between the modeled temperature and the measured temperature. From graph 750, the residual values are distributed randomly and normally (evenly distributed vertically and horizontally) with almost all residual values fall within +200 μK and −200 μK. This indicates that the calculation method developed is an accurate and reliable approximation of the thermal behaviours of the sample. In contrast, graph 700 of FIG. 7 shows the residual values of the same sample where the temperature is predicted using a traditional slab calculation method that does not consider the thermal properties of the insulative backing material. In this case, the residual values are not randomly or normally distributed, and instead includes values ranging from −3000 μK to +2000 μK, indicating a poor approximation and poor fit using the existing method where the properties of the insulative backing material is not considered. These figures demonstrate the importance of considering the thermal properties of the insulative backing material in the determination of sample material properties.

It would be appreciated by one of ordinary skill in the art that the system and components shown in the figures may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms “comprises” and “comprising” and variations thereof mean that the specified features, steps, or components are included. The terms are not to be interpreted to exclude the presence of other features, steps, or components.

The invention may also broadly consist in the parts, elements, steps, examples and/or features referred to or indicated in the specification individually or collectively in any and all combinations of two or more said parts, elements, steps, examples, and/or features. In particular, one or more features in any of the embodiments described herein may be combined with one or more features from any other embodiment(s) described herein.

1. A thermal property measurement method, comprising:
obtaining measurement data from a transient plane source sensor having a first surface in contact with a slab of sample material, wherein an insulative backing material is in contact with the slab of sample material at a surface of the slab of sample material opposite the transient plane source sensor, the measurement data obtained by the transient plane source sensor over a measurement period, and wherein the measurement data includes time data within the measurement period, measured temperature data of the slab of sample material, and a power supplied to the transient plane source sensor over the measurement period, the slab of sample material and the power supplied to the transient plane source sensor over the measurement period being configured to provide a temperature response in an axial boundary of the slab of sample material without providing a temperature response in a radial boundary of the slab of sample material;
determining an initial guess of one or more thermal properties of the slab of sample material;
applying a non-linear fitting technique to determine one or more modeled thermal properties of the slab of sample material using the initial guess of the one or more thermal properties and a temperature equation that is a function of the one or more thermal properties, time, and the power supplied to the transient plane source sensor, the temperature equation considering that the insulative backing material is a perfect insulator or that the insulative backing material has a known set of thermal properties, and wherein the one or more thermal properties of the slab of sample material is a fit parameter in the non-linear fitting technique; and
outputting the one or more modeled thermal properties.

2. The method of claim 1, wherein a second surface of the transient plane source sensor opposite the first surface is in contact with a second slab of sample material, and a second insulative backing material is in contact with the second slab of sample material at a surface of the second slab of sample material opposite the transient plane source sensor, the second slab of sample material and the second insulative backing material being identical to the slab of sample material and the insulative backing material, respectively.

3. The method of claim 2, wherein the temperature equation considers that the insulative backing material has a known set of thermal properties.

4. The method of claim 2, wherein the slab of sample material is anisotropic.

5. The method of claim 1, wherein a second insulative backing material is in contact with a second surface of the transient plane source sensor opposite the first surface.

6. The method of claim 5, wherein the slab of sample material is anisotropic.

7. The method of claim 5, wherein the slab of sample material is isotropic.

8. The method of claim 5, wherein the temperature equation considers that the insulative backing material has a known set of thermal properties.

9. The method of claim 5, wherein the temperature equation considers that the insulative backing material is a perfect insulator.

10. The method of claim 1, wherein a thermal conductivity of the insulative backing material is less than one thirtieth of an expected thermal conductivity of the slab of sample material.

11. The method of claim 1, wherein the slab of sample material has a height that is less than a radius of the transient plane source sensor and greater than 0.03 times the radius of the transient plane source sensor, and the slab of sample material has a radius that is larger than two times the radius of the transient plane source sensor.

12. The method of claim 1, further comprising determining a modeled volumetric heat capacity from the one or more modeled thermal properties.

13. The method of claim 1, wherein the temperature equation is further a function of volumetric heat capacity, and the volumetric heat capacity is a further fit parameter in the non-linear fitting technique and is determined, and the method further comprises determining an initial guess of the volumetric heat capacity.

14. The method of claim 1, wherein the temperature equation is further a function of volumetric heat capacity, and the method further comprises receiving user input of a value for the volumetric heat capacity.

15. The method of claim 1, wherein the temperature equation is further a function of a temperature offset caused by the transient plane source sensor, and the temperature offset is a further fit parameter in the non-linear fitting technique and is determined, and the method further comprises determining an initial guess of the temperature offset.

16. The method of claim 1, wherein the temperature equation is further a function of a time offset, and the time offset is a further fit parameter of the non-linear fitting technique and is determined, and the method further comprises determining an initial guess of the time offset.

17. The method of claim 1, wherein the one or more modeled thermal properties of the slab of sample material each comprise one of: thermal diffusivity, thermal conductivity, and thermal effusivity.

18. The method of claim 1, wherein any one or more of the one or more modeled thermal properties comprises an axial thermal conductivity, an axial thermal diffusivity, an axial thermal effusivity, a radial thermal conductivity, a radial thermal diffusivity, or a radial thermal effusivity.

19. The method of claim 1, wherein the non-linear fitting technique is applied to a time window of the time data that is a subset of the measurement period, and the method further comprises calculating modeled temperatures outside the time window using the modeled directional thermal properties.

20. A thermal property measurement system, comprising:
a processor; and
a non-transitory computer-readable memory storing computer-executable instructions which, when executed by the processor, configure the system to perform the method of claim 1.
